(19) United States
(12) Patent Application Publication
(10) Pub. No.: US 2026/0088593 A1
(43) Pub. Date: Mar. 26, 2026

(54) A BIRD ELECTROCUTION PROTECTION METHOD AND SYSTEM

(71) Applicant: KRONOS AERIAL PHOTOGRAPHY LTD., Petach Tikva (IL)

(72) Inventor: Machluf Eliyahu MALKA, Tel-Aviv (IL)

(21) Appl. No.: 19/118,141

(22) PCT Filed: Nov. 6, 2023
(86) PCT No.: PCT/IL2023/051137

§ 371 Date: Apr. 3, 2025

Related U.S. Application Data
(60) Provisional application No. 63/383,238, filed on Nov. 10, 2022.

(51) Int. Cl. H02G 1/02; B64U 20/80; B64U 101/25

(52) U.S. Cl. CPC H02G 1/02; B64U 20/80; B64U 2101/25; B64U 2201/10; B64U 2201/20

(57) ABSTRACT

The present invention provides systems and methods for placing anti-electrocution protective covers on an electric-pole's insulator bushings.

### FIELD OF THE INVENTION

The present invention is in the technical field of electric power cables/grids. More particularly, the present invention relates to the protection of birds from electrocution from electric poles. Even more particularly, the present invention relates to electrocution-protection devices and methods and systems for placing thereon on electric poles.

### BACKGROUND

Electric power is an essential requirement for humankind and the availability of electricity has become a part of the standard of living. The transport of electricity from power plants to users is done mainly via aboveground powerlines, which are spread for long distances. However, electric power cables and wires, as well as the electric poles holding them, constitute a major threat to birds that tend to rest and nest on them, which may lead to fatal injuries and death of the birds. This is particularly true for large birds such as raptors, storks, herons, etc.

Despite the efforts and attempts to minimize the electrocution of birds, electrocutions still constitute an important, continuing mortality factor of birds. Some bird species, i.e., that are active in the vicinity of powerlines, such as large birds of prey, are more susceptible to electrocution risk than others. The risk of electrocution is due to short-circuiting caused when the birds sit on an electric pole and/or a conducting cable (short circuit between phases, or short-to-ground).

Various attempts were made to prevent or minimize birds' electrocution risks. The most effective one is probably simply placing the cables underground. Another effective solution is to insulate all powerlines. However, both are very expensive solutions that pose many engineering problems.

The most common and effective solution to prevent the electrocution of birds on electric poles is an insulation unit (usually made of plastic) that is placed onto an insulator bushing at the top of each electric pole. However, the installation of such insulation unit requires manual work, which is slow, pose a high risk to the workers, and is problematic in remote and hard-to-reach areas (e.g., geographical remoteness, waterbeds, rivers, lakes, cliffs, forests, rough terrain, etc.)

Accordingly, a need exists for a simple, cost-effective, and safe way to install insulation units on insulator bushings in electric poles. The present invention provides such methods and systems therefore.

### SUMMARY OF THE INVENTION

In a first aspect, the present invention provides a method for placing an anti-electrocution protective cover (102) on an electric-pole's insulator bushings and electric cable (201) attached thereto, the method comprising the steps of: (i) providing an unmanned aircraft vehicle (UAV); (ii) connecting a protective cover (102) comprising a central wider section (108) and two arms (110) to said UAV; (iii) positioning said UAV above the insulator bushing; (iv) lowering the protective cover (102) until the central wider section (108) rests on the insulator bushing; (v) further lowering the arms (110) of the protective cover (102) until they rest on electric cables (201) connected to said insulator bushing; (vi) anchoring the protective cover (102) onto said insulator bushing or electric cables (201); and (vii) releasing the protective cover (102) from the UAV, wherein the connection of the protective cover (102) to said UAV is electrically insulated to prevent unintentional electric damage to the UAV.

In a second aspect, the present invention provides a system for placing an anti-electrocution protective cover (102) on an electric-pole's insulator bushing according to the method of any one of the above embodiments, the system comprising: (i) at least one protective cover (102); (ii) an unmanned aircraft vehicle (UAV) designed to carry said at least one protective cover (102); (iii) a vision system designed to provide images and identify at least said electric-pole's insulator bushing; and (iv) a computing system comprising a processor, a memory, and a designated image and lidar analyzing algorithm, designed to receive data from said vision system, and control the UAV's movement and positioning of the protective cover (102) on said insulator bushing.

### BRIEF DESCRIPTION OF THE DRAWINGS

FIG. 1 is an illustration of the reasons for the electrocution of birds from electric poles.

FIGS. 2A-2B are pictures of known protective measures placed on electric poles: FIG. 2A shows a pointed rack, and FIG. 2B shows plastic covers over the electric-pole's insulating bushings and cables.

FIGS. 3A-3C are illustrations of a protective plastic cover that can be placed onto an electric-pole's insulator bushing using the system of the invention: FIG. 3A is a side-view; FIG. 3B is a bottom-view; and FIG. 3C is a top-view.

FIGS. 4A-4B are illustrations of two points of view of the holder segment associated with the unmanned aircraft vehicle (UAV).

FIG. 5 is an illustration of a locking mechanism for securing the protective plastic cover in place on the cable during assembly (in closed mode).

FIG. 6 is an illustration of a wire-securing mechanism for securing the wires extending from the protective plastic cover holder to the UAV.

FIGS. 7A-7B are illustrations of a protective plastic cover attached to a holder: FIG. 7A is a side-view, and FIG. 3B is a 3-dimensional view.

FIG. 8 is an illustration of a flying drone holding a protective plastic cover and placing thereof onto an electric-pole's insulator bushing.

FIGS. 9A-9C are further illustrations of a flying drone holding a protective plastic cover and placing thereof onto an electric-pole's insulator bushing.

### DETAILED DESCRIPTION OF THE INVENTION

In the conveyance of electricity over powerlines, it is necessary to periodically support the powerlines as well as to connect lines for distribution to various locations. This is done using electric poles, which can be made of metal or wood and may include a cross member to which one or more insulator bushings are attached at its top. The powerline is attached to the insulator bushing in such a manner that the insulator bushing electrically insulates the powerline from the pole.

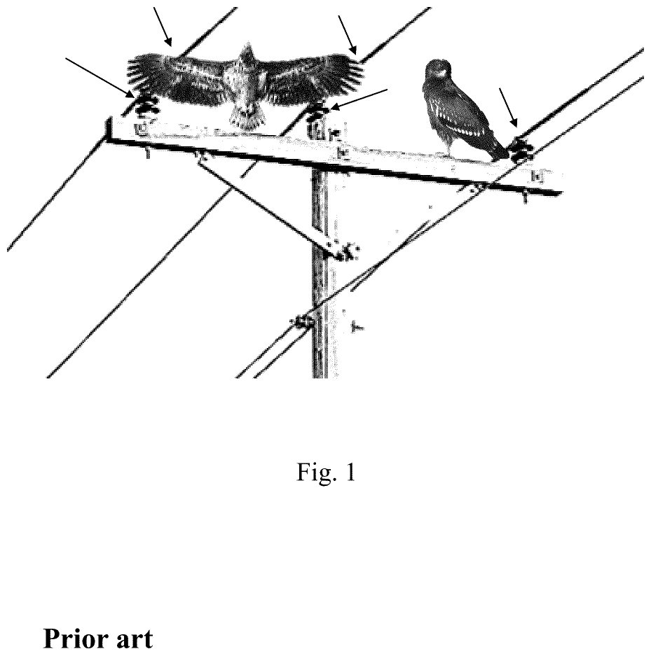

Today, electric poles and the presence of powerlines present a big electrocution risk for birds that use power poles as perching, roosting, and even nesting sites. Birds sit on a power pole (or power cables), e.g., since it provides a convenient location for prey spotting, and thus risk of injury or death due to causing short circuits-either short-to-ground (see FIG. 1, right bird), or between phases when it stretches its wings while attempting to take flight or maintain its balance (see FIG. 1, left bird), in which case the wings may contact two different powerlines. Thus, it is advantageous to avoid contact between a bird and a powerline while the bird resides on the power pole.

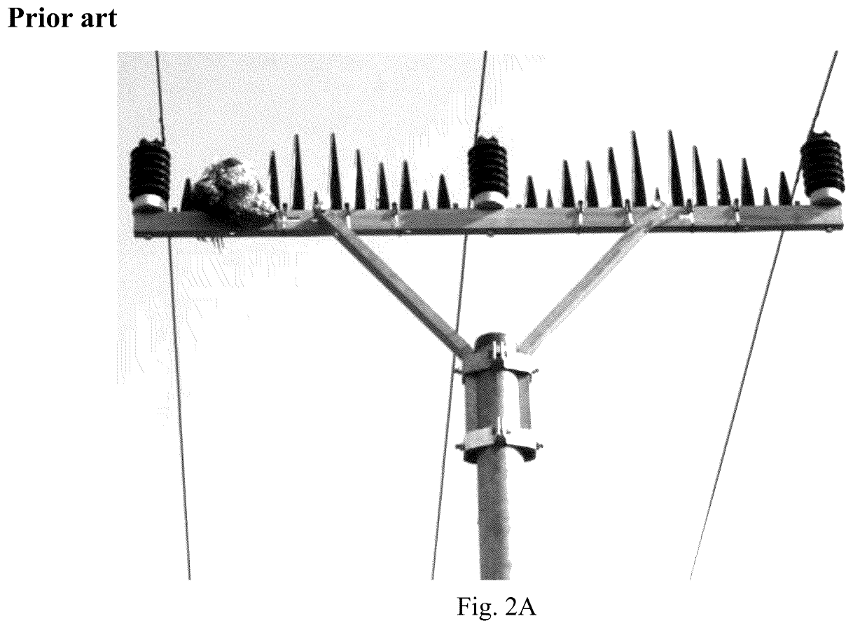

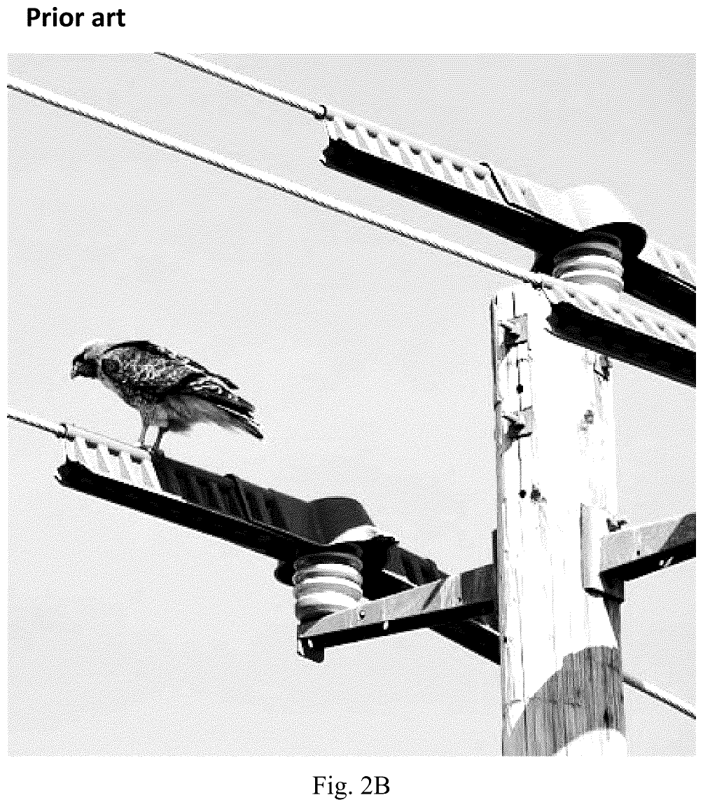

To minimize wildlife being electrocuted, it has become common practice to place an insulating cover over the powerlines and insulator bushings which pose the main risk. Many covers have been developed to cover various configurations of the powerlines, such as pointy racks (FIG. 2A), plastic hoods, silicon tubes, long rod insulators, plastic insulators, metal console covers, etc.

The best solutions are those which allow the birds to securely perch on poles. One such solution is provided in US 2021/0166838 describing an insulating cover (FIG. 2B) that can be placed on various fixed and movable angles of the powerlines, and angles that are the same or different from the insulator bushing sides.

However, all known solutions require manual assembly, which is dangerous, complicated, time-consuming, expensive, and many times physically impossible.

The present invention provides a cheap and easy solution for placing and anchoring protective covers over electric poles' insulator bushings and powerlines by using an unmanned aircraft vehicle (UAV) that delivers the cover to the electric poles' top and places it on top of the insulator bushings and powerlines without the need of an individual or other manual labor. This provides a safe, fast, and convenient way to place protective covers on electric pole tops, which can be done essentially anywhere, even in remote and hard-to-reach locations.

Accordingly, in a first aspect, the present invention provides a method for placing an anti-electrocution protective cover (102) on an electric-pole's insulator bushings and electric cable (201) attached thereto, the method comprising the steps of: (i) providing an unmanned aircraft vehicle (UAV); (ii) connecting a protective cover (102) to said UAV; (iii) positioning said UAV above the insulator bushing; (iv) lowering the protective cover (102) until it rests on the insulator bushing; (v) anchoring the protective cover (102) onto said insulator bushing; and (vi) releasing the protective cover (102) from the UAV, wherein the connection of the protective cover (102) to said UAV is electrically insulated to prevent unintentional electric damage to the UAV.

In a specific embodiments thereof, the present invention provides a method for placing an anti-electrocution protective cover (102) on an electric-pole's insulator bushings and electric cable (201) attached thereto, the method comprising the steps of: (i) providing an unmanned aircraft vehicle (UAV); (ii) connecting a protective cover (102) comprising a central wider section (108) and two arms (110) to said UAV; (iii) positioning said UAV above the insulator bushing; (iv) lowering the protective cover (102) until the central wider section (108) rests on the insulator bushing; (v) further lowering the arms (110) of the protective cover (102) until they rest on electric cables (201) connected to said insulator bushing; (vi) anchoring the protective cover (102) onto said insulator bushing or electric cables (201); and (vii) releasing the protective cover (102) from the UAV, wherein the connection of the protective cover (102) to said UAV is electrically insulated to prevent unintentional electric damage to the UAV.

In certain embodiments of the method according to any of the embodiments above, step (ii) of connecting the protective cover (102) to said UAV is via a dedicated holder (101) designed to suspend the cover horizontally below the UAV using cables (104). In specific embodiments, the holder (101) comprises two parts: an upper part (101a) for attaching to the UAV, and a lower part (101b) for holding the protective cover (102). In further specific embodiments, the two parts are connected to one another via cables (104). In More specific embodiments, said cables (104) are electrically insulated.

It should be noted that the step of anchoring the protective cover (102) onto said insulator bushing or electric cables (201) can be carried out either while the cover (102) is still connected to the UAV (i.e., still connected to the holder (101) holding it), or after the cover has been released from the holder.

In certain embodiments of the method according to any of the embodiments above, the step of lowering the arms (110) onto the electric cables (201) is done by lowering the UAV. Alternatively, it is done by extending the wires connecting the upper section of the holder (101a) to the lower section (101b). In further embodiments, while lowering the arms (110), the UAV shifts position or orientation (i.e., turns or twists) to align the arms (110) with the electric cable (201) and enable proper placement thereof. This can be done separately for each arm (110).

In certain embodiments, the UAV is a remotely piloted aircraft (RPA). In alternative embodiments, the UAV is a completely autonomous aircraft, equipped with a computing system that receives input from various sensors and camera(s), and enables its flight, maneuvering and placing of the cover autonomously while avoiding obstacles such as the electric cables.

In certain embodiments, when the UAV is an RPA, the method of the invention is “Visual Line of Sight” (VLOS) or “Extended Visual Line of Sight” (EVLOS).

The term “Visual Line of Sight” (VLOS) as used herein means that the flight of the UAV is within the visual line of sight of the remote operator.

The term “Extended Visual Line of Sight” (EVLOS) as used herein means that the flight of the UAV can be beyond visual line of sight of the remote operator, e.g., by using external observers that keep the UAV in their line of sight to guide the remote operator and assist in preventing collision. In certain embodiments, when the method of the invention is EVLOS, the external observer(s) is an additional UAV equipped with a vision system, designed to send images or video (optionally wirelessly) to the remote operator.

In specific embodiments, when the UAV is a completely autonomous aircraft, the method of the invention is “Beyond Visual Line of Sight” (BVLOS or BLOS).

The term “Beyond Visual Line of Sight” (BVLOS or BLOS) as used herein means that the flight of the UAV is carried out without a visual line of sight of the remote operator or other external observers. This can be done, e.g., using Remote Pilot Station (RPS) or Ground Control Station (GCS) instruments. A UAV that is operated BVLOS does not have the protection of the pilot or observer to avoid terrain, obstacles, or other aircraft (called ‘See and Avoid’ or ‘Detect and Avoid’ (DAA)).

In an alternative or added embodiment, the method according to any of the embodiments above further comprises a step of launching one or more secondary UAVs equipped with, e.g., a vision system, various sensors, and optionally a positioning system, which is designed to communicate with the UAV that carries the protective cover and assist in its positioning and placing of the protective cover on the insulator bushing. In specific embodiments thereof, the secondary UAV is designed to send images or video (optionally wirelessly) to either a remote operator or a computing system (optionally in the UAV that carries the protective cover) to assist in the operation and navigation of the UAV.

In certain embodiments, the method according to any of the embodiments above further comprises a preliminary step of conducting a preliminary survey and identifying suitable and problematic poles for installation. This is required in order to know, e.g., the number and type of covers that are needed, the required equipment and possible problems, etc.

In certain embodiments of the method according to any of the embodiments above, step (ii) of connecting the protective cover to the UAV is done by connecting a single protective cover to the UAV, and the placing of the covers is carried out one-by-one. In alternative embodiments, the connecting of the protective cover to the UAV is done by connecting to the UAV a caseate holding 2 or more protective covers, in which case, the UAV can place two or more protective covers in a single flight thereby, e.g., saving time and optionally battery life.

In certain embodiments of the method according to any of the embodiments above, step (iii) of positioning said UAV above the insulator bushing is carried out by using a vision system mounted on said UAV and/or said dedicated holder (101), wherein the vision system is designed to provide images of the protective cover, the electric-pole's insulator bushing, and the electric cables (201), thereby assist in the positioning and placing the protective cover (102) on the insulator bushing. In alternative or added embodiments, this step is carried out using one or more vision systems, such as those installed on one or more secondary UAVs flying around and aiding the UAV carrying the cover, human observers, one or more ground-based vision systems, etc., or any combination thereof.

Notably, the term “vision system” as used herein refers to any system that includes one, two, three, four, or more image-capturing devices, such as cameras of any type, e.g., visual camera, heat-sensors, electricity-identifiers, etc., that are designed to identify the electric cables and/or the insulator bushing.

In certain embodiments of the method according to any of the embodiments above, step (iv) of lowering the protective cover until it rests onto said insulator bushing is carried out by: (a) using a vision system mounted on the UAV carrying the cover; and/or (b) a positioning system mounted on said UAV. In alternative or added embodiments, this step is performed by: (a) lowering the entire UAV; or (b) maintaining the UAV in place while lowering only the protective cover, in which case the protective cover is connected to the UAV via extendable wires or arms.

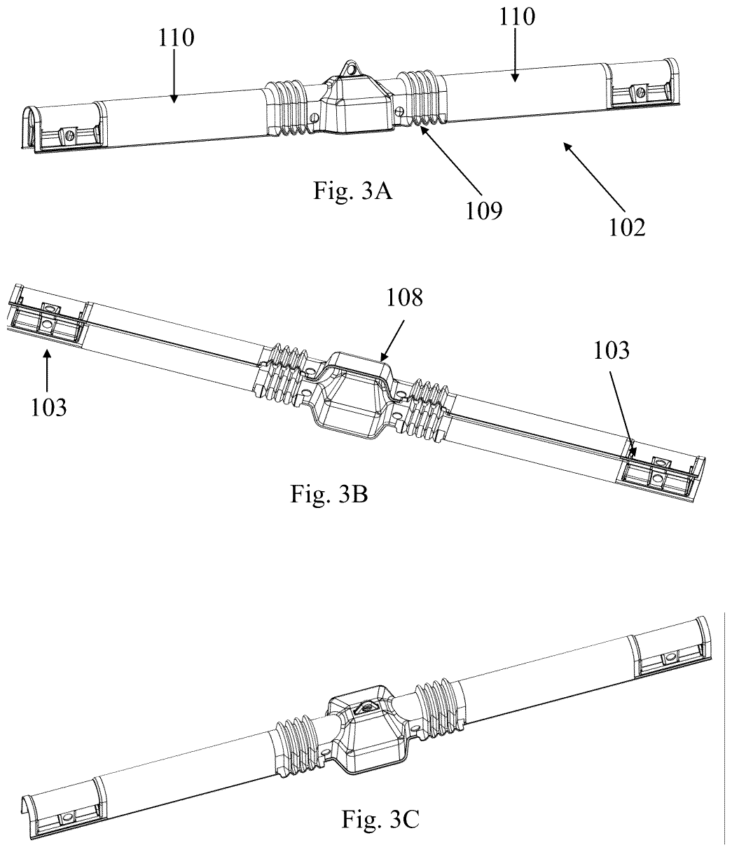

In certain embodiments of the method according to any of the embodiments above, step (v) of anchoring the protective cover onto said insulator bushing or electric cable (201) is performed: (i) automatically once the protective cover is accurately placed onto said insulator bushing and electric cable (201), e.g., using a self-locking mechanism that is either a part of the protective-cover's shape or body or is attached thereto, or is a part of the designated holder (101) (see, e.g., 103 in FIG. 3). For instance, such a mechanism may include a spring-like mechanism that once it engulfs an electric cable, a spring is released, and the lock snaps into a locked mode to secure the cover onto the cable; (ii) after releasing the protective cover from the UAV, e.g., using a dedicated arm(s) that is part of the UAV or the holder (101), or another UAV, in which case the arm(s) may turn screws, insert pins, fold a locking mechanism onto the cable, etc.; and/or (iii) via pins, screws or springs, or any combination thereof.

In certain embodiments of the method according to any of the embodiments above, the UAV comprises an anti-collision system designed to protect the UAV and the protective cover it carries from colliding with the electric pole, the electric cables, and any other obstacle in the flight path.

In certain embodiments, the method according to any of the embodiments above is completely autonomous. In such a case, all steps are carried out automatically using the UAV's computing system, such as connecting the protective cover to the UAV; flying the UAV and positioning it above the insulator bushing; lowering, anchoring, and releasing the protective cover after its positioning onto the insulator bushing, or any combination thereof. In specific embodiments, the step of connecting the protective cover to the UAV may be carried out manually.

All known methods and systems for placing a protective cover onto on an electric-pole's insulator bushings and/or electric cable (201) electric wires pose an electrocution risk. As such, they require turning the power off before the actual installation. Contrary thereto, the present method can be carried out while electricity still runs through the electric cable (201), i.e., without turning the power off, which is one of the disadvantages of current known methods.

The present invention further provides a system for placing an anti-electrocution protective cover on an electric-pole's insulator bushing according to the method of any one of the preceding embodiments, the system comprising: (i) at least one protective cover (102); (ii) an unmanned aircraft vehicle (UAV) designed to carry said at least one protective cover (102); (iii) a vision system designed to provide images and identify at least said electric-pole's insulator bushing; and (iv) a computing system comprising a processor, a memory, and a designated image and lidar analyzing algorithm, designed to receive data from said vision system, and control the UAV's movement and positioning of the protective cover (102) on said insulator bushing.

In specific embodiments thereof, the UAV further comprises an anti-collision system, and said computing system also receives data therefrom to control the UAV's movement and positioning of the protective cover (102) on said insulator bushing.

In certain embodiments, the present invention provides a system for placing an anti-electrocution protective cover on an electric-pole's insulator bushing according to the method of any one of the preceding embodiments, the system comprising: (i) an unmanned aircraft vehicle (UAV) with an anti-collision system; (ii) a vision system designed to provide images and identify at least said electric-pole's insulator bushing; (iii) a computing system comprising a processor, a memory, and a designated image and lidar analyzing algorithm, designed to receive data from said anti-collision system and said vision system, and control the UAV's movement and positioning of the protective cover on said insulator bushing; and (iv) at least one protective cover.

In certain embodiments of the system according to any of the embodiments above, the UAV further comprises a positioning system, and said computing system also receives data therefrom to control the UAV's movement and positioning of the protective cover (102) on said insulator bushing.

In certain embodiments, the system according to any of the embodiments above further comprises a secondary UAV designed to provide a different point of view relative to that of the UAV carrying the protective cover (102), wherein said computing system also receives data from said secondary UAV to control the movement of the UAV carrying the protective cover and the positioning of the protective cover (102) on said insulator bushing.

In certain embodiments of the system according to any of the embodiments above, the UAV is either wirely connected to a base station or is wireless.

As explained above, all known methods and systems for placing a protective cover onto on an electric-pole's insulator bushings and/or electric cable (201) electric wires require to turn the power off before installing to cover. Contrary thereto, the present system, according to any of the embodiments above, can be used to place protective covers on electric-pole's insulator bushings and/or electric cable (201) while electricity still runs through the electric cable (201), i.e., without turning the power off.

In certain embodiments of the above system, the UAV further comprises an insulated unit connecting the protective cover's carrying mechanism, such that the UAV will not be accidentally electrocuted if the protective cover or the carrying wires/mechanism touch the electric cables or due to any other reason. In specific embodiments, the insulated unit is an insulated rope (104) made of insulated material such as plastic. Such rope is optional, and the UAV may connect directly to a unique holder (101b) that holds and keeps the protective cover spread open during carrying and installation.

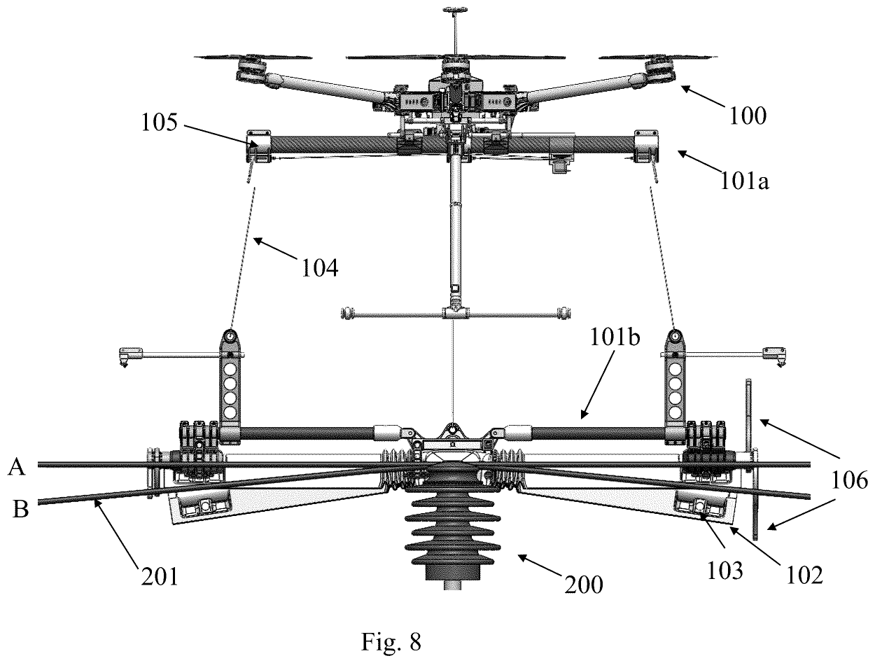

In certain embodiments, and as illustrated in FIG. 8, the protective cover (102) is connected to the holder (101b), and the holder (101b) is connected to the UAV (100) via an insulated cable (104). The length of the rope (104) can vary, and in certain embodiment can be connected to a winch (not shown) that allows lifting and lowering of the protective cover (102) while the UAV (100) hovers in place. Also illustrated is the anchoring mechanism (103) in the protective cover, which is responsible for securing the cover (102) to the electric cable/wire (201). In certain embodiments, the UAV (100) further includes a camera or other positioning system (not shown) which is designed to enable placing the cover over the insulator bushing (200) and electric cables (201) in the right position and location.

Notably, the holder (101b) is positioned close to the center of gravity of the UAV (upper position) to avoid swing affect thereof.

In certain embodiments of the system according to any of the embodiments above, the UAV further comprises a lowering and lifting mechanism for lowering the protective cover onto the insulating bushing while the UAV hovers safely above the electric pole and cables.

As illustrated in FIG. 8, the protective cover (102) may be rigid for placing the cover (102) onto straight electric cables, or be flexible or have a middle flexible area, which enables placing the cover (102) even on electric wires that are not straight.

In certain embodiments of the invention, the constellation holding/securing the protective cover to the UAV is a fixed arm without hinges, such that maneuvering the protective cover is carried out by maneuvering the entire UAV. Alternatively, the constellation holding/securing the protective cover to the UAV is an active mechanism that can lower and lift the protective cover, and optionally move it right-and-left or side-to-side, in which case the maneuvering of the protective cover towards its position on the insulator bushing is carried out by maneuvering the entire UAV and/or the constellation itself.

In certain embodiments of the system according to any of the embodiments above, the UAV further comprises a positioning system, and said computing system also receives data therefrom to control the UAV's movement and positioning of the protective cover on said insulator bushing.

In certain embodiments of the system according to any of the embodiments above, the vision system is ground-based and/or part of the UAV carrying the protective cover and/or of one or more secondary UAVs designed to provide an additional point of view(s) and perspective to the UAV carrying the protective cover to prevent its collision with possible obstacles.

Accordingly, in certain embodiments, the system according to any of the embodiments above further comprises one or more secondary UAVs designed to provide one or more different points of view to the UAV carrying the protective cover.

The UAV(s) of the invention may further be equipped with an anti-collision system, which prevents unintentional collision with trees, electric poles, electric wires, people, and other drones, and enables safe navigation in a complex environment. This anti-collision system includes, but is not limited to, an IR range opto-coupler, ultrasonic range measurement, stereoscopic camera, RADAR, and vision camera. The UAVs of the invention may have a protection net/cage designed to protect the UAV's propellers from hazards.

The system of the invention can be wired, meaning that the UAV carrying the protective cover is connected, e.g., to a base station, with a wire to provide the UAV with, e.g., power, control the UAV manually, flight data in case the UAV is autonomous, instructions for placing the protective cover in place, etc. In alternative embodiments, the system can be wireless, meaning that the UAV flies without being connected to a (ground) station, in which case, the UAV is equipped with a battery (optionally rechargeable, and optionally rechargeable via photovoltaic cells onto the UAV) and means for wirelessly transmitting and receiving data, such as flight plan/instructions, hazards, etc.

In certain embodiments, the power source of the UAV of the invention is a rechargeable power source. In specific embodiments, the power source is replaceable, such that it can be easily replaced within seconds so as to allow continuous work without the need for a long recharging period. In certain embodiments, the power source of the UAV of the invention is a fast-charging power unit, such that when the device returns to upload an additional protective cover, it can be recharged within seconds by a nearby charger. In specific embodiments, said fast-charging power unit is a supercapacitor.

In certain embodiments of the system according to any of the embodiments above, the UAV is either a remotely piloted aircraft (RPA) or a completely autonomous aircraft.

In certain embodiments, the UAV according to the invention comprises a positioning unit (GPS or LPS or ultra-wide-band or visual positioning system).

In certain embodiments of the system of the invention, the computing system enables the system and UAV to be completely independent/autonomous so that there is no need for manual control.

In certain embodiments, the system according to any of the embodiments above is designed to operate as VLOS, EVLOS, or BVLOS.

Specific, non-limiting, embodiments of the invention will now be illustrated with reference to the accompanying figures, in which:

FIGS. 3A-3C illustrate a protective cover (102) that can be used by the systems and according to the methods of any of the embodiments above. As illustrated, the cover (102) has a central wider section (108) designed to fit onto the insulator bushing, and two long arms (110) designed to fit onto the electric cable (201) from each side of the bushing. It should be noted that the arms (110) can be of the same or different lengths, or one is completely absent-depending on the electric-pole's design. Also illustrated are flexible regions (109) connecting the arms (110) to the central wider section (108) to enable flexible movement of the arms (110) for a better fitting thereof to the electric cables that are connected to the bushing (and which are not necessarily in a straight line therewith). In addition, illustrated is an anchoring mechanism (103) at the arms (110) designed to anchor the arms to the electric cable once the cover is in place. Notably, the anchoring mechanism (103) may by placed at any point along the arm, and/or more than one mechanism may be present for each arm. Also, an additional one or more such mechanisms may be located at the central wider section (108) (not shown).

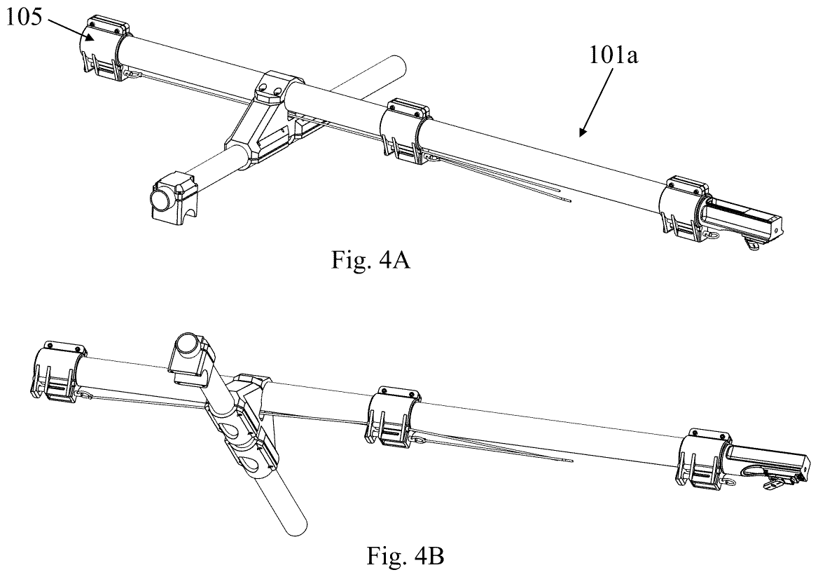

FIGS. 4A-4B illustrate the upper segment (101a) of the holder, which is designed to be associated with the UAV. This section comprises at least two connectors (105)—one at each end-designed to connect cables (104), that are optionally insulated, for carrying the lower section (101b) of the holder (101) that holds the cover (102). As illustrated in FIG. 6, the connector (105) has a quick-release pin (111) for, e.g., releasing the lower section (101b) in case it, e.g., entangles.

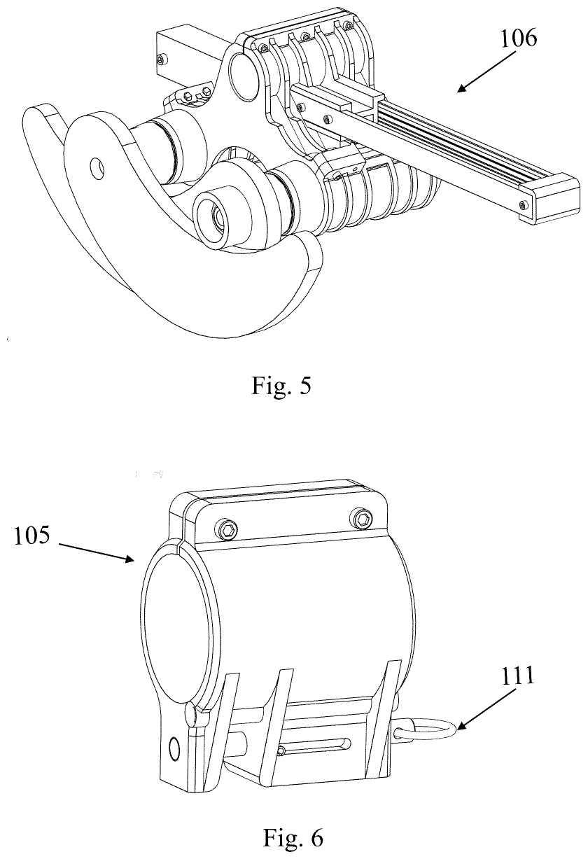

FIG. 5 is an illustration of a locking mechanism (106) designed to secure the lower portion of the holder (101b) in place on the electric cable during the assembly of the cover onto the bushing: when the cover is lowered onto the bushing and the arms (110) are lowered onto the electric cables, the locking mechanism (106) closes onto the electric cables thereby preventing unintentional movement or dislocation of the cover or its arms while the anchoring mechanisms (103) within the cover are activated to lock the cover in place. Once the anchoring mechanisms (103) have secured the cover, the locking mechanism (106) re-opens, the cover is released from the lower portion of the holder (101b), and the UAV (and the holder (101) attached thereto) can move away from the electric-pole.

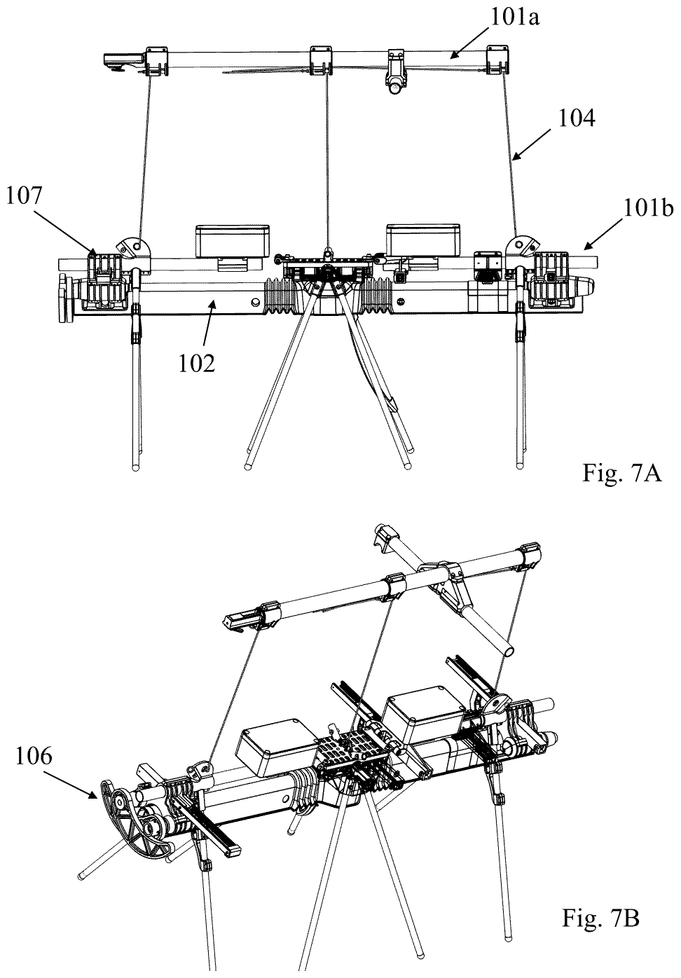

FIGS. 7A-7B are illustrations of a protective plastic cover attached to a holder, without a UAV. As illustrated, the holder (101) comprises an upper section (!01a) designed to be attached to the UAV, and a lower section (101b) designed to hold the cover (102). In this illustration, the connection between the upper-and lower-sections (101a, 101b) is via cables (104), that are optionally insulated. In specific embodiments, the cables (104) may be extended or shortened according to need, e.g., to adjust the arms' (110) height or angle. Notably, although FIG. 7 illustrates 3 wires (104), there can be only two wires (104)—one on each side, without the middle wire. Alternatively, additional wires may be present. In specific embodiments, the holder (101) may include a motor for whirling the wires (104).

In alternative embodiments, the upper-and lower-sections (101a, 101b) are fixedly connected creating a single unit, i.e., connected with a fixed frame.

In further embodiments, the holder (101) may be equipped with a camera, e.g., extended sideway to provide a side-perspective during installation of the cover.

FIGS. 7A-7B further illustrate closing mechanisms (107) that are part of the holder (101) and are designed to close the anchoring mechanisms (103) that reside within the cover onto the electric cable. In alternative embodiments, i.e., when the cover does not comprise or include such anchoring mechanisms (103) integrated therewith, the closing mechanisms (107) of the holder (101) may hold external anchoring mechanisms that are then used to secure the cover (102) onto the electric cable (201).

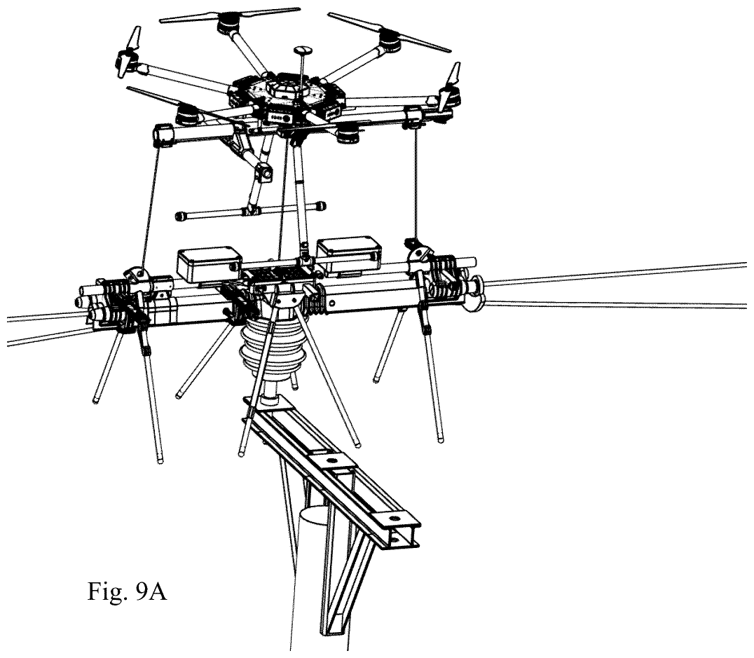

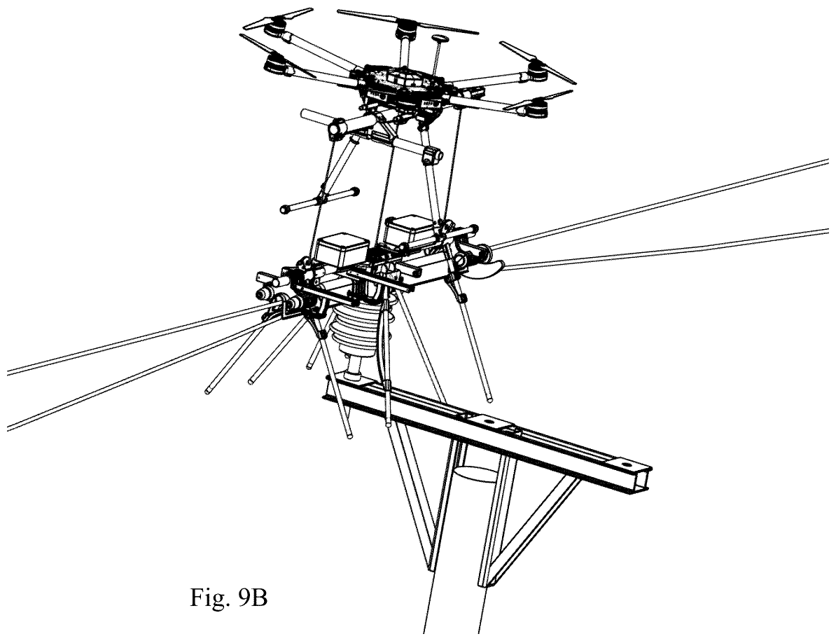

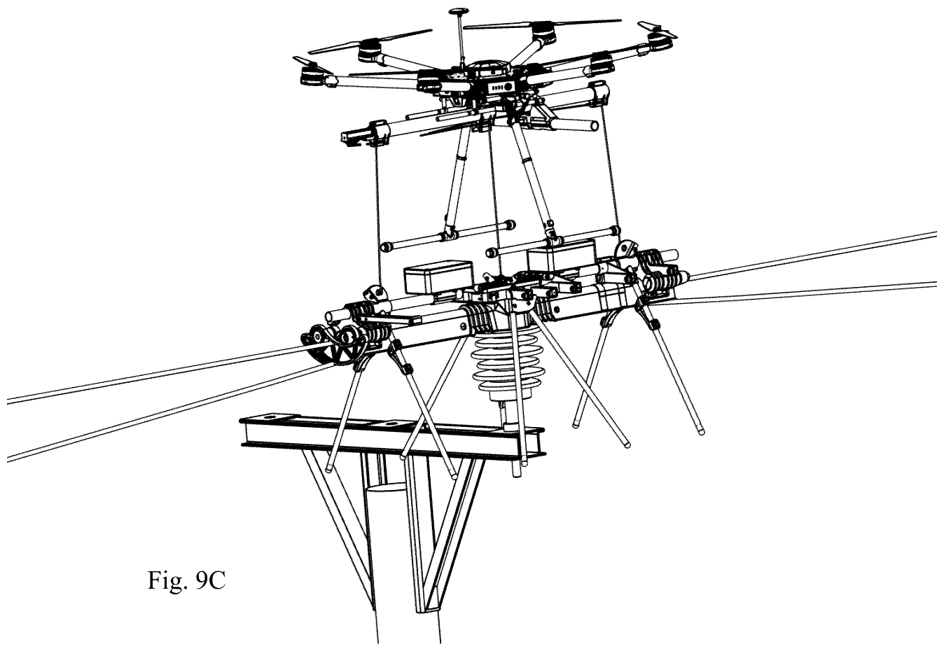

FIGS. 8-9 illustrate the holder (101) and protective plastic cover (102) connected to a flying drone (UAV) that is hovered over an electric-pole. As illustrated, if the cover (102) includes flexible regions (109) when the protective cover (102) is lowered onto the bushing and cable (201), the side arms (110) may be lowered until they reside onto the cables (201) from both sides of the bushing, even if the cables (201) are not in a straight line with the bushing (see “B”).

1.-28. (canceled)

29. A method for placing an anti-electrocution protective cover on an electric-pole's insulator bushings and electric cable attached thereto, the method comprising the steps of:
i) providing an unmanned aircraft vehicle (UAV);
ii) connecting a protective cover comprising a central wider section and two arms to said UAV;
iii) positioning said UAV above the insulator bushing;
iv) lowering the protective cover until the central wider section rests on the insulator bushing;
v) further lowering the arms of the protective cover until they rest on electric cables connected to said insulator bushing;
vi) anchoring the protective cover onto said insulator bushing or electric cables; and
vii) releasing the protective cover from the UAV,
wherein the connection of the protective cover to said UAV is electrically insulated to prevent unintentional electric damage to the UAV.

30. The method of claim 29, wherein step (ii) of connecting the protective cover to said UAV is via a dedicated holder designed to suspend the cover horizontally below the UAV using cables.

31. The method of claim 29, wherein said UAV is a remotely piloted aircraft (RPA).

32. The method of claim 31, which is based on “Visual Line of Sight” (VLOS) or on “Extended Visual Line of Sight” (EVLOS).

33. The method of claim 29, wherein said UAV is an autonomous UAV that is based on “Beyond Visual Line of Sight” (BVLOS or BLOS).

34. The method of claim 33, further comprising a step of launching one or more secondary UAVs equipped with a vision system and optionally positioning system, for communicating with the UAV that carries the protective cover and assisting in the positioning and placing of the protective cover on the insulator bushing.

35. The method of claim 29, further comprising a preliminary step of conducting a preliminary survey and identifying suitable and problematic poles for installation.

36. The method of claim 29, wherein step (ii) of connecting said protective cover to the UAV is by connecting to said UAV a caseate holding two or more protective covers.

37. The method of claim 29, wherein step (iii) of positioning said UAV above the insulator bushing is carried out by using a vision system mounted on said UAV or said dedicated holder, which is designed to provide images of the protective cover and the electric-pole's insulator bushing and thereby assist in the positioning and placing of the protective cover on the insulator bushing.

38. The method of claim 29, wherein step (iv) of lowering the protective cover until it rests on said insulator bushing is carried out by: (a) using a vision system mounted on said UAV or said holder; and/or (b) a positioning system mounted on said UAV or said holder.

39. The method of claim 29, wherein step (iv) of lowering the protective cover until it rests onto said insulator bushing is performed by: (a) lowering the entire UAV; or (b) maintaining the UAV in place while lowering only the protective cover, in which case the protective cover is connected to the UAV via extendable cables or arms.

40. The method of claim 29, wherein step (v) of anchoring the protective cover onto said insulator bushing is performed automatically once the protective cover is accurately placed on said insulator bushing.

41. The method of claim 29, wherein step (v) of anchoring the protective cover onto said insulator bushing or electric cable is performed after releasing the protective cover from the UAV.

42. The method of claim 29, which is completely autonomous.

43. The method of claim 29, which is carried out while electricity runs through the electric cable.

44. A system for placing an anti-electrocution protective cover on an electric-pole's insulator bushing according to the method of claim 29, the system comprising:
i) at least one protective cover;
ii) an unmanned aircraft vehicle (UAV) designed to carry said at least one protective cover;
iii) a vision system designed to provide images and identify at least said electric-pole's insulator bushing; and
iv) a computing system comprising a processor, a memory, and a designated image and lidar analyzing algorithm, designed to receive data from said vision system, and control the UAV's movement and positioning of the protective cover on said insulator bushing.

45. The system of claim 44, wherein said UAV further comprises an anti-collision system and said computing system also receives data therefrom to control the UAV's movement and positioning of the protective cover on said insulator bushing.

46. The system of claim 44, wherein said UAV further comprises a positioning system and said computing system also receives data therefrom to control the UAV's movement and positioning of the protective cover on said insulator bushing.

47. The system of claim 44, further comprising a secondary UAV designed to provide a different point of view relative to that of the UAV carrying the protective cover, wherein said computing system also receives data from said secondary UAV to control the movement of the UAV carrying the protective cover and the positioning of the protective cover on said insulator bushing.

48. The system of claim 44, which is designed to place an anti-electrocution protective cover on an electric-pole's insulator bushing and electric cable, while electricity runs through the electric cable.
